(19) United States
(12) Patent Application Publication
(10) Pub. No.: US 2005/0144067 A1
(43) Pub. Date: Jun. 30, 2005

(54) Identifying and reporting unexpected behavior in targeted advertising environment

(75) Inventors: Ayman O. Farahat, San Francisco, CA (US); Hermann Calabria, Los Altos, CA (US); Francine R. Chen, Menlo Park, CA (US); Daniel H. Greene, Sunnyvale, CA (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: PALO ALTO RESEARCH CENTER INCORPORATED

(21) Appl. No.: 10/742,380

(22) Filed: Dec. 19, 2003

(51) Int. Cl. G06F 17/60

(52) U.S. Cl. 705/14

(57) ABSTRACT

A method for generating or determining data sources useful for detecting non-conforming behavior associated with pay-per-click advertising in a keyword searching environment includes: a) observing behavior associated with the pay-per-click advertising, b) predicting behavior associated with the observed behavior, and c) comparing the observed behavior to the predicted behavior to identify unexpected behavior associated with the pay-per-click advertising. In another embodiment, a method of monitoring behavior associated with targeted advertising in a keyword searching environment is provided. In another aspect, an apparatus for monitoring behavior associated with targeted advertising in a keyword searching environment includes: at least one observed behavior model, at least one predicted behavior model, and at least one comparator logic process to identify non-confirming behavior associated with the targeted advertising.

### BACKGROUND

The present exemplary embodiment relates to targeted advertising associated with or found within a regular search results list generated, for example, by an Internet search engine in response to a keyword query submitted by a user. It finds particular application in conjunction with identification of unexpected behavior in a targeted advertising environment and subsequent reporting of such behavior, and will be described with particular reference thereto. However, it is to be appreciated that the present exemplary embodiment is also amenable to other like applications.

An increasingly popular way of delivering Internet advertisements is to tie the advertisement to search query results. In order to target advertising accurately, advertisers or vendors pay to have their advertisements presented in response to certain kinds of queries—that is, their advertisements are presented when particular keyword combinations are supplied by the user of the search engine.

For example, when a user searches for “deck plans,” using a search engine such as Google or AltaVista, in addition to the usual query results, the user will also be shown a number of sponsored results. These will be paid advertisements for businesses, generally offering related goods and/or services. In this example, the advertisements may therefore be directed to such things as deck plans, lumber, wood sealers, or even design automation software. Of course, the advertisements may be directed to seemingly less related subject matter. While the presentation varies somewhat between search engines, these sponsored results are usually shown a few lines above, or on the right hand margin of the regular results. Although, the sponsored results may also be placed anywhere in conjunction with the regular results.

Keyword advertising is growing as other types of web advertising are generally declining. It is believed there are at least several features that contribute to its success. First, sponsored results are piggybacked on regular results, so they are delivered in connection with a valuable, seemingly objective, service to the user. By contrast, search engines that are built primarily on sponsored results have not been as popular. Second, the precision of the targeting of the advertising means the user is more likely to find the advertisements useful, and consequently will perceive the advertisements as more of a part of the service than as an unwanted intrusion. Unlike banners and pop-up advertisements, which are routinely ignored or dismissed, users appear more likely to click through these sponsored results (i.e., keyword advertisements). Third, the targeting is based entirely on the current query, and not on demographic data developed over longer periods of time. This kind of targeting is timelier and more palatable to users with privacy concerns. Fourth, these advertisements reach users when they are searching, and therefore when they are more open to visiting new web sites.

Companies, such as Google of Mountain View, Calif. (which offers a search engine) and Overture of Pasadena, Calif. (which aggregates advertising for search engines as well as offering its own search engine), use an auction mechanism combined with a pay-per-click (PPC) pricing strategy to sell advertising. This model is appealing in its simplicity. Advertisers bid in auctions for placement of their advertisements in connection with particular keywords or keyword combinations. The amount they bid (i.e., cost-per-click (CPC)) is the amount that they are willing to pay for a click-through to their link. For example, in one PPC pricing strategy, if company A bids $1.10 for “deck plans” then its advertisement will be placed above a company bidding $0.95. Only a selected number of bidders' advertisements will be shown. The simplicity of the model makes it easy for an advertiser to understand why an advertisement is shown, and what bid is necessary to have an advertisement shown. It also means that advertisers are charged only for positive responses.

Both Google and Overture offer tools to help users identify additional keywords based on an initial set of keywords. The Overture model supplies keywords that actually contain the keyword (e.g. for bicycle one can get road bicycle, Colonago bicycle, etc.). Google, on the other hand, performs some kind of topic selection, which they claim is based on billions of searches.

Both Google and Overture offer tools to help users manage their bids. Google uses click-through rate and PPC to estimate an expected rate of return which is then used to dynamically rank the advertisements. Overture uses the PPC pricing strategy to rank advertisements, but monitors the click-through rate for significantly under performing advertisements.

Because Google dynamically ranks the advertisements based on click-through and PPC, advertisers cannot control their exact advertisement position with a fixed PPC. To insure a top position, the advertiser must be willing to pay a different price that is determined by their own click through rate as well as the competitors click-though rates and PPC. Overture uses a fixed price model, which insures fixed position for fixed price.

If a set of keywords that have not been selected by any of the advertisers is issued as a search term, Google will attempt to find the best matching selected set of keywords and display its associated advertisements. For example, let's say a user searches on “engagement ring diamond solitaire.” However, there are no advertisers bidding on this search term. The expanded matching feature will then match (based on term, title and description) selected listings from advertisers that have bid on search terms like “solitaire engagement ring” and “solitaire diamond ring.”

A number of third parties provide services to Overture customers to identify and select keywords and track and rank bids. For example, BidRank, Dynamic Keyword Bid Maximizer, Epic Sky, GoToast, PPC BidTracker, PPC Pro, Send Traffic, and Sure Hits. There are a small number of pay-per-bid systems. For example, Kanoodle is a traditional pay-per-bid system like Overture. Other examples, include Sprinks and FindWhat.

Sprinks' ContentSprinks™ listings rely on context, as opposed to one-to-one matching with a keyword. The user chooses topics, rather than keywords. The web site says “Since context is more important than an exact match, you can put your offer for golf balls in front of customers who are researching and buying golf clubs, and your listing will still be approved, even though it's not an exact match.” This is a pay-per-bid model, like Overture, and has been used by About.com, IVillage.com and Forbes.com. KeywordSprinks™ is a traditional pay-per-bid model for keywords and phrases system.

FindWhat has a BidOptimizer that shows the bids of the top five positions so that a user can set their bid price for a keyword to be at a specific position. It does not continually adjust bids like E-Bay and Overture.

In addition, there is a system called Wordtracker for helping users to select keywords. The Wordtracker system at <www.wordtracker.com> provides a set of tools to help users to identify keywords for better placement of advertisements and web pages in search engines, both regular and pay-per-bid. Wordtracker provides related words with occurrence information, misspelled word suggestions based on the number of occurrences of the misspelled words, and tools for keeping track of possible keyword/key phrase candidates. The related words are more than variants. On the web site, an example of related keywords for “golf” includes pga, Ipga, golf courses, tiger woods, golf clubs, sports, jack nicklaus, and titleist, as well as phrases that include the term “golf,” such as golf clubs, golf courses, golf equipment, used golf clubs, golf tips, golf games, and vw.golf. Wordtracker displays the bid prices for a keyword on selected pay-per-bid search engines. It also displays the number of occurrences of search terms by search engine so the keywords can be tuned to each search engine.

This is a very effective business model. However, PPC and pay-per-bid pricing strategies are vulnerable to a number of problems associated with non-conforming behavior, such as automated clicks, low relevance advertisements, and web spam, by participants in the keyword search engine environment. For example, with respect to automated clicks, the PPC model is vulnerable to a number of non-conforming behaviors that are either directed towards a competitor's advertising or a PPC provider. Imagine for example the situation where an advertiser “A” was the highest bidder for one or more keywords. A competitor of “A” can have an automated agent that first queries the search engine with the keywords of other competitors and then repetitively and/or continuously clicks “A's” advertisement a large number of times. Every time the advertisement is clicked “A” will have to pay the PPC operator the price associated with the relevant keywords.

Low relevance advertisements are another situation where the PPC model can be attacked. This is when the textual content of an advertisement and its associated keyword combinations do not match (i.e., the keywords are not relevant to the advertisement and there is a low probability of the advertisement being selected) resulting in a low click-through rate. Studies on web log analysis, such as Optimizing Search Engines Using Click-Through Data, Thorsten Joachims, KDD 2002, have shown that the correlation between the query term and the abstracts presented by the search engine is an important predictor of click-through rate. The problem is particularly acute when the top placing ads (which account for over 80% of the traffic to advertisers' sites) are not relevant to the search engine query term. The impact of this problem has been recognized by Google and others, which rank advertisements based on their CPC and click-through rate. This ranking system intends to maximize the overall return for Google and other such providers and rewards well-targeted relevant advertisements. However, according to this model, advertisements that have a high click-through rate will be presented at the top of the list. Therefore, when an advertiser is the highest bidder they are presented at or near the top, which means, at least for a time, they will probably get more clicks. This situation can pose a grave challenge for other advertisers whose advertisements will be pushed further down the list. In order to compensate for the low ranking, they might have to increase their bids significantly to offset the initial click-through factor.

Overture and others on the other hand uses a ranking system based on price which insures that the highest bidder will get the top spot, the second highest bidder the second spot, and so forth. Overture and others monitor the click rate through a simple “Click-Index” model that compares actual and historical click-through rates. Some advertisers prefer this model because of its simplicity and the control they have on their advertisement placement. However, this model is even more susceptible to low relevance advertisements, since the ranking is dependent only on the bid price.

Another situation where problems arise is a procedure where the PPC model piggybacks sponsored advertisements on regular search engine results. The relative position of the actual search engine results has a significant impact on the click-through rate. Web or search engine spam occurs in this scenario when a party designs its web pages to artificially inflate its search engine ranking. A variety of techniques such as adding keywords and linking to authoritative pages have been used in web spam. Web spam is a serious problem, since commercial sites that are not part of the PPC program can get significantly higher click-through rates by virtue of their search query rank.

To address non-conforming type behavior, some search engines already offer a level of protection against non-conforming type behavior to their PPC advertisers. This includes such things as not charging for click-throughs from IP addresses where language or geography would suggest that the user is not likely to be a customer of the advertiser. In addition, some search engines have encoded query time and (unique user identities) UIDs in the click-through links, to make it difficult for a malicious bot to repeatedly access a particular link. Finally, a time window is sometimes used to avoid charging the advertisers for multiple click-throughs from the same machine.

It is considered that if processes for combating various types of non-conforming behavior were automated or more automated, it is likely that non-conforming behavior could be reduced by search engines and advertisement aggregators. The present exemplary embodiment contemplates a new and improved keyword searching environment with new and improved automation, including various components that identify and report non-conforming, unexpected, or suspicious (i.e., potentially fraudulent) behavior.

### BRIEF DESCRIPTION

In accordance with one aspect of the present exemplary embodiment, a method of generating or determining data sources useful for detecting non-conforming behavior associated with pay-per-click advertising in a keyword searching environment is provided. The method includes: a) observing behavior associated with the pay-per-click advertising, b) predicting behavior associated with the observed behavior, and c) comparing the observed behavior to the predicted behavior to identify unexpected behavior associated with the pay-per-click advertising.

In accordance with another aspect of the present exemplary embodiment, a method of monitoring behavior associated with targeted advertising in a keyword searching environment is provided. The method includes: a) observing behavior associated with the targeted advertising, b) predicting behavior associated with the observed behavior, c) comparing the observed behavior to the predicted behavior to identify non-conforming behavior associated with the targeted advertising, d) storing the non-conforming behavior on a storage device, and e) reporting the non-conforming behavior to an output device.

In accordance with yet another aspect of the present exemplary embodiment, an apparatus for monitoring behavior associated with targeted advertising in a keyword searching environment is provided. The apparatus includes: at least one observed behavior model for identifying observed behavior associated with the targeted advertising, at least one predicted behavior model for identifying predicted behavior associated with the observed behavior, and at least one comparator logic process in communication with one or more of the at least one observed behavior model and one or more of the at least one predicted behavior model for comparing the observed behavior to the predicted behavior to identify non-conforming behavior associated with the targeted advertising.

### BRIEF DESCRIPTION OF THE DRAWINGS

The exemplary embodiment may take form in various components and arrangements of components, and in various steps and arrangements of steps. The drawings are only for purposes of illustrating preferred embodiments and are not to be construed as limiting the exemplary embodiment.

FIG. 1 is a block diagram of an exemplary embodiment of a keyword searching environment showing basic keyword searching operations;

FIG. 2 is a block diagram of another exemplary embodiment of a keyword searching environment showing more detail with respect to monitoring various behaviors in the keyword searching environment;

FIG. 3 is a block diagram of an exemplary embodiment of a keyword searching environment monitor;

FIG. 4 shows a portion of an exemplary advertisement that assists in identifying non-conforming behavior in the keyword searching environment;

FIG. 5 shows a portion of another exemplary advertisement that assists in identifying non-conforming behavior in the keyword searching environment;

FIG. 6 is a block diagram of another exemplary embodiment of a keyword searching environment monitor; and

FIG. 7 is a block diagram of still another exemplary embodiment of a keyword searching environment monitor.

### DETAILED DESCRIPTION

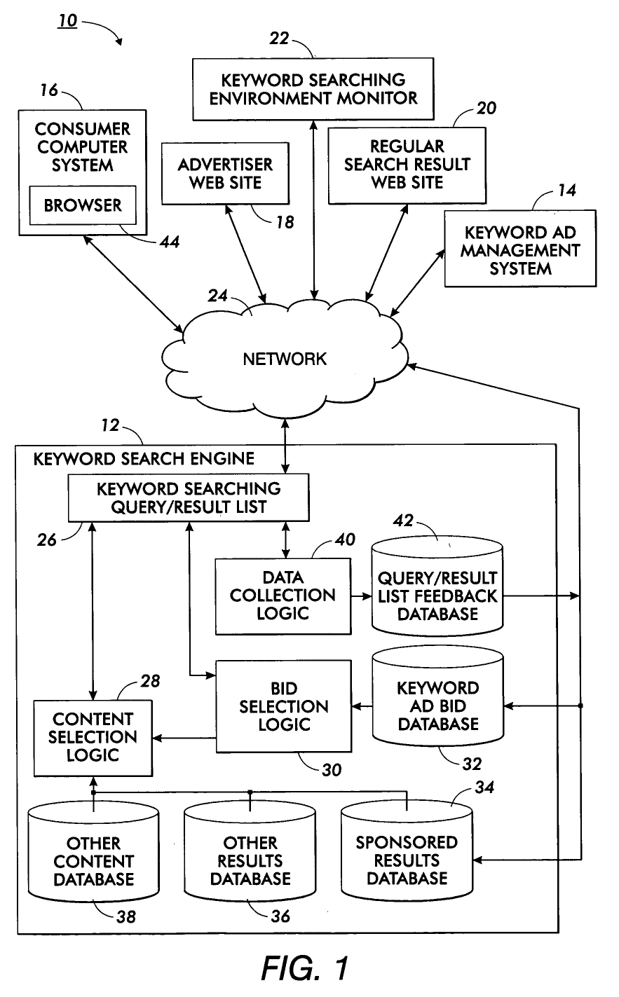

With reference to FIG. 1, an exemplary embodiment of a keyword searching environment 10 includes a keyword search engine 12, a keyword advertisement management system 14, a consumer computer system 16, an advertiser web site 18, a regular search result web site 20, a keyword searching environment monitor 22, and a network 24. The keyword searching environment 10 may be expanded to include a plurality of any one or more of these components. An example of network 24 is what is commonly known as the Internet. However, any combination computer networks and communications networks suitable for data communication can be combined in the network 24. Moreover, the network 24 may be implemented through any combination of multiple networks that provide suitable communication between the components of the environment.

As will be appreciated from the following discussion, the keyword searching environment monitor 22 is described as a standalone component within the environment. It is understood that the keyword search environment monitor 22 may be incorporated within any one or more of the other components in the environment.

The keyword searching environment 10 provides a process for positioning keyword advertising in association with or within a regular search results list generated by the keyword search engine 12 in response to a keyword query from, for example, a consumer computer system 16. It finds application in conjunction with generation of bids by the keyword advertisement management system 14 for positioning of the keyword advertising in the list. The bids may be based on information from various sources.

The keyword search engine 12 includes a keyword search query/result list process 26, a content selection logic process 28, a bid selection logic process 30, a keyword advertisement bid database 32, and a sponsored results (i.e., advertisement) database 34. The keyword search engine 12 may also include one or more of an other results (e.g., non-paid or regular search results) database 36, an other content (e.g., news, information, entertainment, etc.) database 38, a data collection logic process 40, and a query/result list feedback (e.g., keywords used in previous search queries, advertisements displayed in previous search results lists, click-through information for previous search results lists, and descriptive information about consumers that submitted previous search queries, etc.) database 42. Each of these processes and databases may be implemented by any suitable combination of hardware and/or software. One or more of the processes and databases may be combined in any suitable arrangement of hardware and/or software.

The consumer computer system 16 includes a browser process 44, such as Microsoft's Internet Explorer, Netscape, or another similar browser process. The browser process 44 provides users of the consumer computer system 16 with a user interface to submit keyword search queries to the keyword search engine 12 and to display the results generated by the keyword search engine 12 in response to such queries.

The keyword search query/result list process 26 receives a keyword search query from the browser process 44 and communicates the keywords to the content selection logic 28, bid selection logic 30, and the data collection logic 40. The bid selection logic 30 uses advertiser bids for keyword advertisements stored in the keyword advertisement bid database 32 to determine which keyword advertisements will be included in the keyword search results list and the position of such advertisements. This information is communicated to the content selection logic process 28. The content selection logic process 28 selects the appropriate keyword advertisements from the sponsored results database 34, as well as other appropriate content for keyword search results list from the other results database 36 (i.e., non-paid or regular search results) and the other content database 38. The content selection logic 28 communicates the appropriate content to the keyword search query/result list process 26. The keyword search query/result list process 26 compiles the keyword search results list. The result list is communicated to the user at the consumer computer system 16 via the network 24 and displayed to the user by the browser process 44. The keyword search query/result list process 26 also communicates information associated with the result list to the data collection logic process 40 for storage in the query/result list feedback database 42.

The search results list displayed to the user by the browser process 44 includes hyperlinks associated with each sponsored and regular result. When the user clicks on a sponsored result hyperlink associated with an advertisement, the browser displays a web page from the advertiser web site 18 associated with the advertisement. Alternatively, when the user clicks on a hyperlink associated with a non-paid or regular result, the browser displays a web page from the regular search result web site 20 associated with the selected hyperlink.

The keyword searching environment monitor 22 monitors various behaviors within keyword searching environment 10 and, like a watchdog, identifies non-conforming (i.e., suspicious or unexpected) behavior for subsequent evaluation as to whether corrective action or some other form of intervention is necessary. The subsequent evaluation, corrective action, and/or intervention may be manual, interactive (i.e., semi-automatic), automated, or any combination thereof. The various behaviors monitored include behaviors of keyword search engines and advertising aggregators associated with search results lists generated by the keyword search engine 12, users of the consumer computer system 16, advertisers associated with bids for keywords, advertisements, and advertiser web sites 18, and businesses and individuals associated with regular search result web sites 20. In this sense, it is understood that use of the term behavior throughout this text is not restricted to human behavior, rather it is understood to include human behavior and the results of human behavior as described above. Data sources for monitoring such behavior include the advertiser web site 18, regular search result web site 20, and data collection logic 40 via query/result list feedback database 42.

In alternate embodiments, it is understood that auction services for keyword advertisement positions within the keyword search engine 12 may be provided separate from search engine services. For example, the auction services may be provided by an advertising aggregator that operates independently in conjunction with one or more search engines. Thus, for example, the bid selection logic 30, keyword advertisement bid database 32, and sponsored results database 34 may be implemented in a keyword advertisement auction component separate from the keyword search engine.

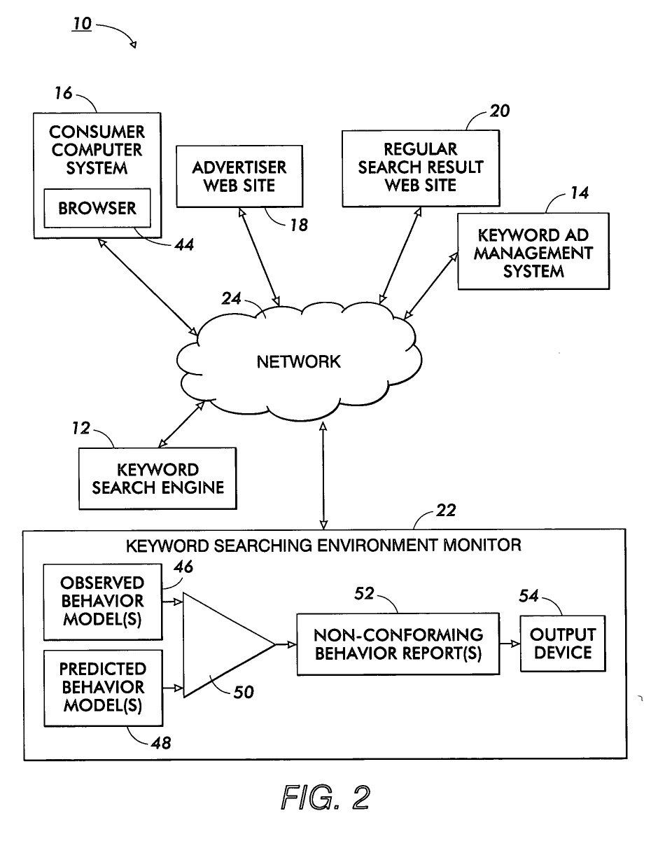

With reference to FIG. 2, the keyword searching environment 10 of FIG. 1 is shown with more detail with respect to monitoring various behaviors in the environment. As in FIG. 1, the keyword searching environment 10 includes the keyword search engine 12, keyword advertisement management system 14, consumer computer system 16, advertiser web site 18, regular search result web site 20, keyword searching environment monitor 22, and network 24. Additionally, the keyword searching environment monitor 22 includes one or more observed behavior models 46, one or more predicted behavior models, a comparator logic process 50, a non-conforming behavior report(s) storage device 52, and an output device 54 suitable for communicating with local users and/or other components within the environment.

The observed behavior model(s) 46 receives data from other components in the keyword searching environment 10. For example, any observed behavior model may receive or retrieve data from the query/result list database 42 (FIG. 1) of the keyword search environment 12, advertiser web site 18, regular search result web site 20, or any combination thereof. The data received or retrieved from the query/result list database 42 (FIG. 1) may include keywords used in previous search queries and associated advertiser bids, advertisement content data for advertisements displayed in previous search results lists, and click-through information from previous search results lists. The data received or retrieved from the advertiser web site 18 may include content data for objects and text included in the web pages linked to sponsored search results. The data received or retrieved from the regular search result web site 20 may include content data for objects and text included in the web pages linked to regular search results.

The predicted behavior model(s) 48 may include static and/or dynamic models. If a predicted behavior model 48 is a static model, it typically includes predetermined thresholds for comparison with observed behavior. If a predicted behavior model 48 is an dynamic model, it typically receives or retrieves data from the query/result list database 42 (FIG. 1) of the keyword search environment 12, advertiser web site 18, regular search result web site 20, or any combination thereof and uses such data to dynamically determine thresholds for comparison with observed behavior.

The comparator logic process 50 effectively compares the observed behavior to the predicted behavior to identify when the observed behavior exceeds normal/acceptable thresholds or tolerances associated with the predicted behavior. If the observed behavior exceeds normal/acceptable thresholds or tolerances associated with the predicted behavior, it is characterized as non-conforming behavior. When non-conforming behavior is identified, it is stored in the non-conforming behavior report(s) storage device 52. Source data to the behavior models, intermediate data determined by the behavior models, and predicted behavior associated with the non-conforming behavior may also be stored in the non-conforming behavior report(s) storage device 52. The non-conforming behavior report(s) storage device 52 may be any suitable storage device using any suitable storage media.

Information stored in the non-conforming behavior report(s) storage device 52 is communicated to the output device 54 where it is accessible by users and other components/processes of the keyword search environment for manual, interactive (i.e., semi-automatic), and/or automated evaluation, corrective action, and/or intervention. The output device 54 may include a display device, a printing device, an e-mail interface, a modem, and/or any other type of device suitable for communicating non-conforming behavior reports to human users and/or equipment associated with the keyword searching environment 10.

In an additional embodiment, the input data and/or results of the predicted behavior model 48 may directly be provided to an output device 54 via the comparator logic process 50 and non-conforming behavior report(s) storage device 52. In this embodiment, output device is further configured to incorporate one of any number of comparison algorithms wherein the non-conforming behavior report 52 is compared to a predicted behavior model 48. Based on this comparison, an advertiser may be charged for predicted behavior click-through rates when it is determined there is a detectable level of non-conforming behavior. In one embodiment, the user would therefore, be requested to pay a lesser of the cost of actual click-through versus an expected predicted click-through.

Thus, output device 54 may simply generate the comparison of these two rates and provide this to a billing system, or output device 54 may be considered a back office billing system wherein a user is automatically billed via the output of the decision making process determined therein.

In a further embodiment, the input data and/or results of the observed behavior model 46 may also be directly passed to output device 54 via the comparator logic process 50 and non-conforming behavior report(s) storage device 52. In this embodiment, once non-conforming behavior report 52 has issued to output device 54, and the non-conforming behavior report 52 identifies non-conforming behavior or the observed behavior is above a certain threshold, the output device may be implemented with algorithms which generate a corrective action based on the observed behavior model 46 and predicted behavior model 48 values. The output of this determining step may alter the costs passed onto an advertiser as in the previous embodiment.

It is to be appreciated, that both of these embodiments may be implemented in the still further to be described embodiments, including the embodiments based on the observed click-through behavior, predicted human user behavior, as well as predicted auto agent behavior, to be described in the following sections.

It is envisioned that the non-conforming behavior and associated data can be used to assist in reducing non-conforming usage within various operations within the keyword searching environment to acceptable levels. Such non-conforming usage includes, for example, click-throughs on sponsored results by an automated agent, low relevance advertisements that are awarded high level positions through the auction process, and web spam in regular search results, wherein commercial low relevance web sites are awarded high level positions through the regular or non-paid search result positioning process. In some search engines, click-throughs by automated agents can raise an advertiser's advertisement position to a more desirable position closer to the top of the search results web page. Low relevance advertisements can reduce search engine revenue if they do not attract click-throughs, frustrate search engine users that click-through to find a non-relevant web page, and block more relevant advertisements from more desirable advertisement positions in the search result web page. Web spam can raise the position of a web page listing in the regular or non-paid search results portion of the search results web page. This provides a free form of advertising to the web spammer and lost revenue to the keyword search engine. Moreover, web spam can create an unfair advertising advantage for the web spammer over competitors participating in auctions for sponsored advertisement positions.

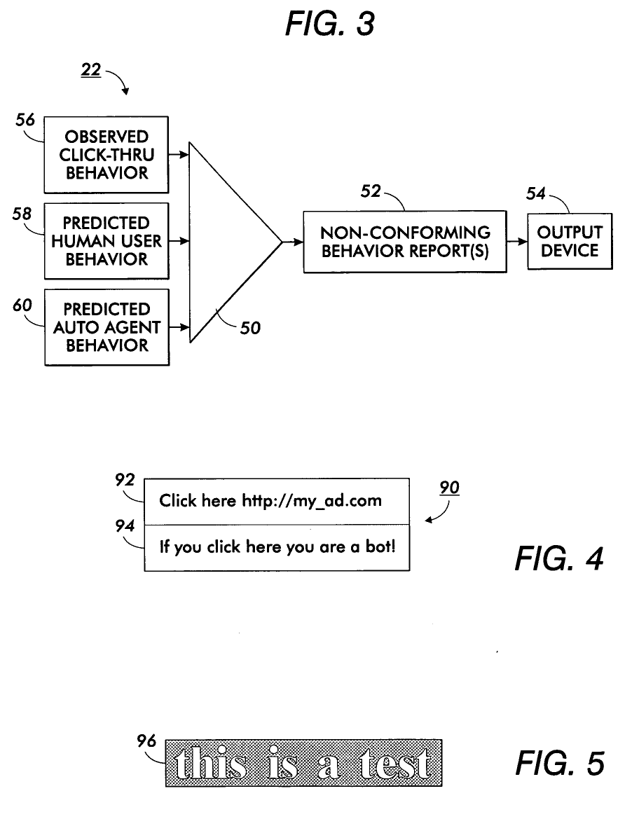

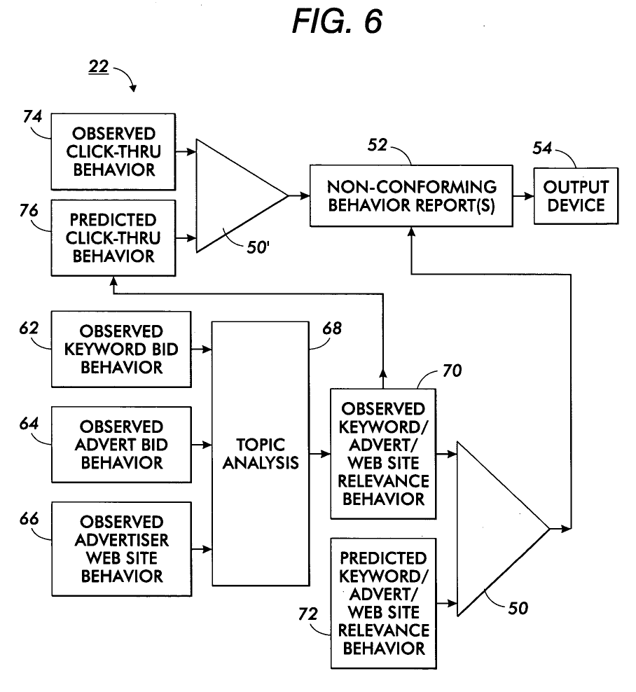

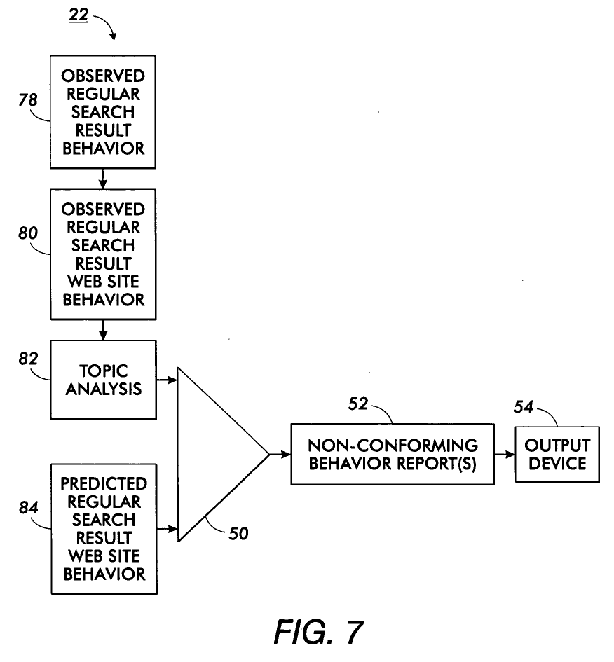

A strategy for using the keyword searching environment monitor 22 for identifying and reducing or eliminating non-conforming behavior can be based on a variety of information sources and analytic techniques. For example, FIGS. 3-7 provide additional details about embodiments that can detect click-throughs by automated agents, (FIGS. 3-5), low relevance advertisements (FIG. 6), and web spam (FIG. 7). Click-throughs by automated agents can, for example, inflate PPC advertising costs for competitors.

With reference to FIG. 3, an exemplary embodiment of a keyword searching environment monitor 22 includes an observed click-through behavior model 56, a predicted human user behavior model 58, and a predicted automated agent behavior model 60. The predicted human user behavior model 58 is optional. Additionally, the keyword searching environment monitor 22 includes first and second comparator logic processes 50, 50′ non-conforming behavior report(s) storage device 52, and output device 54 as shown in FIG. 2.

The observed click-through behavior model 56 receives or retrieves click-through information, such as sponsored results selected from a search results list, the associated keywords, and timing between selections of sponsored results for the associated keywords from the query/result list feedback database 42 (FIG. 1).

In order to detect automated agents clicking on sponsored PPC links, a test is set up that can distinguish a human user from an automated agent. One type of test uses sponsored results (i.e., advertisements) with a plurality of images of text rather than text characters. The images of text can be easily read by humans, yet difficult for a machine to decipher. Certain images can be associated with a Universal Resource Locator (URL) redirect that are not recognized as PPC click-throughs or activations, while at least one image is associated with an appropriate advertiser web site. The images of text associated with the URL redirect may include text to “not click on this image” while the image linked to the advertiser web site may include text to “click on this image.” In particular, the following HTML format may be included in an exemplary advertisement for purposes of this example identified as “my_ad.html” to implement this feature to set up monitoring for non-conforming behavior:

<HTML>
<body>

<img src = “0.gif”><a http//www.mysite.com/cgi_bin/redirect?
ap000 </a>
<img src = “1.gif”><a http//www.mysite.com/cgi_bin/redirect?
ap001 </a>

<\body>
<\HTML>

In this case 0.gif, and 1.gif are images of text included in the actual content of the advertisement 90 shown in FIG. 4. For example, 0.gif may look like the upper image 92 and 1.gif may look like lower image 94. The two hyperlinks in “my_ad.html” (i.e., http://www.mysite.com/cgi_bin/redirect?ap000 and http://www.mysite.com/cgi_bin/redirect?ap001) are redirects to a cgi-script. The input parameter to the script is the quantity after the “?”. Only one input parameter is valid (i.e., “000”) and will redirect the script to the intended web site (i.e., http://www.my_ad.com). The other parameter (i.e., “001”) is an invalid input. This parameter is typically only passed to the script if an automated agent selects the link that does not correspond to a valid image. Thus, the invalid input is not recognized as a PPC event and the advertiser is not charged for the activation. In this way, the system can detect and block attacks from automated agents. Data reflecting click-through behavior for this advertisement is stored in the query/result list feedback database 42. In an alternative configuration the system may be designed so the image in 92 and/or 94 does not include text. Rather, a symbol or icon may be used which would intuitively tell a human to click on an area in order to be directed to the associated web page and/or to avoid clicking on an area.

An automated agent may be able read text characters and detect hyper-linked objects on a web page. However, one type of automated agent may not be able to read text embedded in an image object (i.e., images of text). The advertisement in FIG. 4 with valid and invalid images is a useful countermeasure against this type of automated agent. Another type of automated agent may be able to perform an OCR process on an image object to attempt to detect text embedded in the image. An added countermeasure to this type of automated agent is to transform or degrade the text (e.g., decrease resolution, overlay or remove portions of the text, use color variation through the text and background, etc.). Either of these options make it more difficult for the OCR process to detect the text. An example of an image of text 96 using color transformation or variation that is difficult for OCR systems to detect text characters is shown in FIG. 5. There are many variants that can be used to render text to images. For example, there are free rendering engines on the web, such as www.cooltext.com and www.flamingtext.com that can be used to create difficult to OCR images of text.

The use of image text as an effective component of a human interactive proof has been addressed in Monica Chew and Henry S. Baird, BaffleText: a Human Interactive Proof, Proceedings of SPIE-IS&T Electronic Imaging, SPIE Vol. 5010, 2003, pgs. 305-316, incorporated herein by reference. Such human interactive proof is currently being used in a number of high profile applications, including Yahoo user account registration. In these applications, the primary emphasis is on identifying and blocking robots and the user's interaction with the image text is limited (only when signing up for an account). The image text or CAPTCHA (completely automated public turing tests to tell computers and humans apart) are significantly altered from their most readable form. CAPTCHAs (e.g., BaffleText) trades ease of reading by humans to vulnerability to OCR. In the applications addressed herein, the goal is to make it prohibitively expensive for an attacker (i.e., automated agent) to decipher the image text while making it seamless for a human to navigate through the presented content. In that vein, difficult to read forms of BaffleText may be avoided in favor of more human readable representations. Furthermore, because images require higher bandwidth than regular text; the use of image text can initially be limited to situations where non-conforming behavior (i.e., inappropriate use of automated agents) is suspected. Of course, as the use of broadband communications becomes more prevalent, limitations on the use of image text can be relaxed.

With reference again to FIG. 3, the predicted automated agent behavior model 60 reflects a threshold or percentage of click-throughs expected for valid and invalid hyper-linked images of text. The predicted behavior model may dynamically update its thresholds or percentages based on observed behavior. The keyword advertisement or sponsored listing, for example, may include one valid hyper-linked image of text and two invalid hyper-linked images of text in the advertisement. The predicted automated agent behavior model 60 includes logic based on a premise that automated agents cannot distinguish between valid and invalid images of text and will therefore select all images approximately equally. Thus, the predicted automated agent behavior model 60 in this example may reflect approximately 66% click-throughs for invalid images of text. Note that the use of additional invalid images of text raises the percentage of expected click-throughs on invalid images for automated agents even higher (e.g., 75% for three invalid images with one valid image, 80% for four invalid images with one valid image, etc.).

Similarly, if the predicted human user behavior model 58 is implemented, it may include logic that describes that humans can distinguish between valid and invalid images of text and will therefore usually select only valid images. Thus, the predicted human user behavior model 58 may reflect approximately 100% click-throughs for valid images of text. Of course, certain tolerances, such as ±5%, are typically included within the predicted models because human users may occasionally click on an invalid image and automated agents may not select all images equally. Moreover, another embodiment of the advertisement and corresponding HTML code may detect a suspicious amount of clicks on an invalid image and redirect the user to a web page having a CAPTCHA requiring user input to determine if the user is a human or an automated agent with more certainty.

The predicted human user and automated agent behavior models 58, 60 may also include logic based on premises associated with timing between consecutive sponsored click-throughs for the same search query. Here, for example, if the timing between click-throughs is below a certain threshold, it is more likely that the click-throughs are being made by an automated agent.

The observed click-through behavior and associated predicted behavior are communicated to the comparator logic process 50. The comparator logic process 50 effectively compares the observed behavior to the predicted behavior to identify non-conforming behavior as described above in reference to FIG. 2. Likewise, the non-conforming behavior report(s) storage device 52 and output device 54 operate as described above in reference to FIG. 2.

With reference to FIG. 6, another exemplary embodiment of a keyword searching environment monitor 22 includes an observed keyword bid behavior model 62, an observed advertisement bid behavior model 64, an observed advertiser web site behavior model 66, a topic analysis process 68, an observed keyword bid/advertisement bid/advertiser web site relevance behavior model 70, a predicted keyword bid/advertisement bid/advertiser web site relevance behavior model 72, an observed click-through behavior model 74, and a predicted click-through behavior model 76. Additionally, the keyword searching environment monitor 22 includes first and second comparator logic processes 50, 50′, non-conforming behavior report(s) storage device 52, and output device 54 as shown in FIG. 2.

A variety of document content analysis techniques, originally developed for information retrieval, can be implemented by the behavior models in the keyword searching environment monitor and applied to combating non-conforming behavior associated with low relevance advertisements and/or advertiser web sites. In one aspect, the strategy is based on identifying relevance of advertisements and advertiser web sites to associated keywords. In another aspect, the strategy is based on estimating, refining and monitoring click-through rates.

The observed keyword bid behavior model 62, observed advertisement bid behavior model 64, and observed click-through behavior model 74 receive or retrieve information from the query/result list feedback database 42 (FIG. 1). In an alternate embodiment, the observed keyword bid behavior model 62 may receive or retrieve information from the keyword advertisement bid database 32 and the observed advertisement bid behavior model 64 may receive or retrieve information from the sponsored results database 34. The observed advertiser web site behavior model 66 receives or retrieves information from the advertiser web site 18 (FIG. 1).

The observed keyword bid behavior model 62 identifies keywords on which an advertiser is bidding from the feedback information. The observed advertisement bid behavior model 64 identifies content of an advertisement associated with the keywords on which the advertiser is bidding from the feedback information. The observed advertiser web site behavior model 66 identifies content of the advertiser web site 18 (FIG. 1). The identified keywords, advertisement content, and advertiser web site content are communicated to the topic analysis process 68 to identify topics associated with the keywords, advertisement content, and advertiser web site content. The identified topics are communicated to the observed keyword bid/advertisement bid/advertiser web site relevance behavior model 70 which accumulates and correlates the various observed relationships between the keywords, advertisement content, and advertiser web site content and the relevance of any one to another.

The predicted keyword bid/advertisement bid/advertiser web site relevance behavior model 72 reflects a threshold or percentage of relevance for various combinations of keywords, advertisement content, and advertiser web site content. The predicted behavior model may dynamically update its thresholds or percentages based on observed behavior and/or topic analysis results.

The observed keywords, advertisement content, and advertiser web site content relevance behavior and associated predicted behavior are communicated to the first comparator logic process 50. The first comparator logic process 50 effectively compares the observed behavior to the predicted behavior to identify non-conforming behavior due to low relevance. This operation is generally as described above in reference to FIG. 2. Likewise, the non-conforming behavior report(s) storage device 52 and output device 54 operate as described above in reference to FIG. 2. In one embodiment, the initial behavior models 62,64,66, topic analysis 68, second stage behavior models 70,72, first comparator logic process 50, storage area 52, and output device 54 operate in response to bids from advertisers as they are submitted, permitting pre-auction processing of non-conforming behavior. In another embodiment, non-conforming behavior is processed after selection of advertisements via the auction and construction of the search results list. Of course, pre- and post-auction processing can be selectively implemented in an additional embodiment.

The observed keywords, advertisement content, and advertiser web site content relevance behavior is also communicated to the predicted click-through behavior model 76 where it reflects thresholds or percentages expected for keyword advertisements or sponsored listings associated with certain keywords. This predicted behavior model may dynamically update its thresholds or percentages based on observed click-through behavior.

The observed click-through behavior model 74 receives or retrieves click-through information, such as sponsored results selected from a search results list and the associated keywords from the query/result list feedback database 42 (FIG. 1). The observed click-through behavior and associated predicted behavior are communicated to the second comparator logic process 50′. The second comparator logic process 50′ effectively compares the observed behavior to the predicted behavior to identify non-conforming behavior associated with click-through performance. This operation is generally as described above in reference to FIG. 2. Likewise, the non-conforming behavior report(s) storage device 52 and output device 54 operate as described above in reference to FIG. 2.

As shown in FIG. 6, topic analysis techniques and query log analysis can be applied to score a keyword search query against the contents of a candidate advertisement and its associated advertiser web site. The use of such techniques enhances the ability to estimate expected click-through rate for a given advertisement and keyword search query pair and rank advertisements based on their expected click-through. Motivated by recent success in modeling and predicting search click-through from search engine query logs, the embodiment being described leverages the similarity between search results and sponsored advertisements to develop predictive models for sponsored advertisements. In both cases the user issues a keyword search query term to the keyword search engine and is presented with a number of possible resources (i.e., results). The user judges the relevance of the available resources based on a number of factors including: position in the search results list; relevance of a descriptive summary associated with the result to the keyword search query term, and other features. When a user explicitly selects a specific entry from the list of returned results, the following is implied: “of all the entries presented so far, based on information known to the user, this entry is the most relevant to the user's current needs.” The same relevance model that applies to search results can be extended to sponsored advertisements. Hence, models developed from search engine query logs act as good predictors of click-throughs for sponsored advertisements.

A number of technologies can be readily used to develop predictive models for sponsored advertisements. The use of one or more of latent semantic analysis (LSA), probabilistic LSA (PLSA), machine learning, information foraging, and spreading activation offers a powerful framework for modeling users click-through behavior. Recent work described in Thorsten Joachims, Optimizing Search Engines using Click-through Data, SIGKDD, 2002, herein incorporated by reference, used elements of machine learning (e.g., support vector machine (SVM) and ordinal regression) and content analysis to automatically optimize the retrieval quality of search engines using click-through data. Moreover, Ed H. Chi, Peter Pirolli, and James Pitkow, The Scent of a Site: A System for Analyzing and Predicting Information Scent, Usage, and Usability of a Web Site, CHI '00, 2000, incorporated herein by reference, developed and evaluated models to predict which link a user is most likely to follow given the users information needs. The combination of both approaches provides more accurate models of click-through.

The estimates obtained by the predictive models provide useable initial estimate of click-through rates. As actual click-through data becomes available, it can be used to update the initial estimates using a predictor-corrector model (e.g., Kalman Filter). The Kalman filter provide estimates of click-through rates as well as their associated statistics (e.g., the actual click-through is a binomial process, so an estimate of the mean of the process, probability of selecting the particular advertisement, and variance of the mean). The different conversion rates are then compared using statistical hypothesis testing to decide if any of the conversion rates is significantly different from their expected values.

Another approach is to use statistical testing to identify significant differences between predicted and measured click-throughs and report these differences. In deciding whether an unexpected increase in traffic at a particular web site is a result of non-conforming behavior or can be attributed to another factor (e.g., advertising or the web site being featured on a specialty site (e.g., Slashdot or on the “Today” show) techniques are used from marketing research described in Alan L. Montgomery and Wendy W. Moe, Should Record Companies Pay for Radio Airplay? Investigating the Relationship between Album Sales and Radio Airplay, Wharton Marketing Department Working Paper #00-018 (revising for Marketing Science), June 2000, incorporated herein by reference.

With reference to FIG. 7, still another exemplary embodiment of a keyword searching environment monitor 22 includes an observed regular search result behavior model 78, an observed regular search result web site behavior model 80, a topic analysis process 82, and a predicted regular search result web site behavior model 84, in addition to the comparator logic process 50, non-conforming behavior report(s) storage device 52, and output device 54.

One of the most popular and effective ways of artificially inflating the rank of a regular search result listing in response to a specific keyword search query is to include one or more of the keyword search query terms a large number of times in the content of a given web page. In order to overcome this problem, some search engines perform a semantic analysis on the content of the web page to determine if the page is a legitimate web page with coherent well-written text or whether the page is nothing more than a bunch of keywords inserted to increase the rank of the web page in regular search results lists. While this technique has been partially effective in reducing naïve forms of web spam, it has been extremely vulnerable to sophisticated spam techniques that rely on replacing phrases in well-written text with the selected keyword search query terms. While these spam methods are extremely difficult to detect using semantic analysis, a detailed topic analysis can reveal differences between the overall topic of the document and the topics corresponding to one or more keywords.

The observed regular search result behavior model 78 receives or retrieves regular search results information, such as regular search results listings, from the query/result list feedback database 42 (FIG. 1). This behavior model identifies regular search result web sites that are highly ranked (e.g., top ten regular search results, top two percent of regular search results, etc.). The highly ranked regular search results are communicated to the observed regular search result web site behavior model 80. The observed regular search result web site behavior model 80 receives or retrieves content from the web sites corresponding to the highly ranked regular search results. The content from the highly ranked regular search result web sites is communicated from the observed regular search result web site behavior model 80 to the topic analysis process 82 to identify topics associated with the content of the highly ranked regular search results and topics associated with the keywords associated with the corresponding search results list.

The predicted regular search result web site behavior model 84 reflects a threshold or percentage for relationships between keyword topics and aggregate topics associated with the web site content. The predicted behavior model may dynamically update its thresholds or percentages based on observed behavior.

The topics associated with the keywords and regular search result web sites and associated predicted behavior are communicated to the comparator logic process 50. The comparator logic process 50 effectively compares the observed behavior to the predicted behavior to identify non-conforming behavior associated with click-through performance. This operation is generally as described above in reference to FIG. 2. Likewise, the non-conforming behavior report(s) storage device 52 and output device 54 operate as described above in reference to FIG. 2.

In particular, LSA or PLSA techniques can be used to compute the topic distribution of the entire web page or document (or alternatively, the visible text). Based on the topic distribution, phrases that have a significantly high and/or low probability of being included in the document (p(w/d) probability of word or phrase given the document) can be automatically identified. If a low probability phrase occurs a large number of times or is one of a list of popular phrases, the web document is flagged as non-conforming for potentially containing spam. On the other hand, for a high probability phrase that occurs a large number of times or is one of a list of popular phrases, the phrase may be removed from the document and its topic distribution may be recomputed. If the topic distribution changes significantly from its previous value (i.e., the rest of the document is topically different from that particular term) the document is flagged as non-conforming for potentially containing spam.

In summary, any one of the data gathering and analysis techniques described above for the keyword searching environment monitor would be useful to keyword search engines, advertising aggregators, and/or advertisers. A non-conforming behavior management solution might incorporate any combination of the above techniques to identify and report non-conforming behavior. For example, in one scenario an advertiser supplies an advertisement (and the web site associated with the advertisement) to an advertisement tool (i.e., auction process and keyword search engine process). The tool processes the advertisement, advertiser web site, and keyword search query terms and provides historical data to the keyword searching environment monitor to predict the relevance of the advertisement to the selected keyword search query terms. The different advertisements associated with the search query are ranked based on their expected click-through rate. Advertisements that have a significantly low expected click-through rate are flagged and examined manually.

Also in this scenario, a user queries the keyword search engine and the search results and relevant sponsored advertisements are retrieved and compiled in a search results list. The sponsored advertisements are encoded using image text and URL redirect techniques. The user selects one or more of the sponsored advertisements. The click-through rate for the advertisement is updated and compared to predicted and historical values. If the click-through rate falls outside the allowable range, human guidance is solicited. This combination of features in the keyword searching environment monitor allows keyword search engines, advertising aggregators, and advertisers to overcome non-conforming usage patterns in PPC models.

In one embodiment, the keyword searching environment monitor uses an image-based puzzle (easily solved by humans but not by machines) and URL redirect of multiple links (only some of which are valid) to identify a click-through event of economic value by a machine. The HTML is modulated such that the output on the screen is identical, yet the bot or automated agent would be confused about the link on which to click. In another embodiment, the keyword searching environment monitor uses content analysis to predict normal click-through rates, and thereby detect potentially non-conforming activity. The keyword searching environment monitor may also use advertising models to dynamically predict normal click-through rates. In still another embodiment, the keyword searching environment monitor uses content analysis to detect unusual manipulation of the text of a web page or document, and thereby detect attempts to engineer better placement in regular or non-paid search results lists (i.e., unpaid advertising). As discussed, the keyword searching environment monitor may combine these techniques in any manner, especially when any one technique points to non-conforming behavior.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method for generating or determining data sources useful for detecting non-conforming behavior associated with pay-per-click advertising in a keyword searching environment, the method including the steps:
a) observing behavior associated with the pay-per-click advertising;
b) predicting behavior associated with the observed behavior; and
c) comparing the observed behavior to the predicted behavior to identify unexpected behavior associated with the pay-per-click advertising.

2. The method as set forth in claim 1 wherein the observed behavior is based on data from two or more components in the keyword searching environment.

3. The method as set forth in claim 2 wherein the data from the two or more components includes at least one of keyword data, advertisement content data, sponsored search results data, regular search results data, click-through data, advertiser web site content data, or regular search result web site content data.

4. The method as set forth in claim 2 wherein the two or more components include at least one of a keyword search engine, an advertiser web site, or a regular search result web site.

5. The method as set forth in claim 1 wherein the observed behavior includes at least one of click-throughs on sponsored search results by automated agents, low relevance sponsored advertisements in relation to corresponding keywords, low relevance advertiser web site in relation to corresponding keywords, or web spam in regular search result web site.

6. The method as set forth in claim 1, further including:
d) storing the unexpected behavior in a storage device.

7. The method as set forth in claim 6, further including:
e) reporting the unexpected behavior to an output device.

8. The method as set forth in claim 1 wherein the observed behavior is processed using at least one of an observed click-through behavior model, an observed keyword bid behavior model, an observed advertisement bid behavior model, an observed advertiser web site behavior model, an observed regular search result behavior model, an observed regular search result web site behavior model, or a topic analysis process.

9. The method as set forth in claim 1 wherein the predicted behavior is dynamically adjusted based on the observed behavior.

10. The method as set forth in claim 1 wherein the predicted behavior is processed using at least one of a predicted human user behavior model, a predicted automated agent behavior model, a predicted keyword, advertisement content, and advertiser web site content relevance behavior model, a predicted click-through behavior model, or a predicted regular search result web site behavior model.

11. A method of monitoring behavior associated with targeted advertising in a keyword searching environment, the method including the steps:
a) observing behavior associated with the targeted advertising;
b) predicting behavior associated with the observed behavior;
c) comparing the observed behavior to the predicted behavior to identify non-conforming behavior associated with the targeted advertising;
d) storing the non-conforming behavior on a storage device; and
e) reporting the non-conforming behavior to an output device.

12. The method as set forth in claim 11 wherein the observed behavior is observed using an advertisement including at least one valid image associated with a first hyper-link and at least one invalid image associated with a second hyper-link.

13. The method as set forth in claim 12 wherein the second hyper-link is not recognized as a pay-per-click event.

14. The method as set forth in claim 12 wherein one or more of the at least one valid image or the at least one invalid image is an image including text.

15. The method as set forth in claim 14 wherein the image has been modified using one or more methods for detecting an automated agent.

16. The method as set forth in claim 15 wherein the method for detecting the automated agent includes at least one of transformation or degradation.

17. The method as set forth in claim 11 wherein the observed behavior is processed using at least one of a latent semantic analysis model, a probabilistic latent semantic analysis model, a machine learning model, an information foraging model, a spreading activation model, or a Kalman filter.

18. The method as set forth in claim 11 wherein the predicted behavior is processed using at least one of a latent semantic analysis model, a probabilistic latent semantic analysis model, a machine learning model, an information foraging model, a spreading activation model, or a Kalman filter.

19. The method as set forth in claim 18 wherein the predicted behavior model uses at least one of an observed click-through behavior, an observed keyword bid behavior, an observed advertisement bid behavior, an observed advertiser web site behavior, an observed regular search result behavior, or an observed regular search result web site behavior.

20. The method as set forth in claim 1 further including:
providing the identified unexpected behavior to an output device including billing logic, used to determine a bill associated with the pay-per-click advertising;
providing the predicted behavior to the billing logic;
comparing the identified unexpected behavior with the predicted behavior; and
adjusting the bill associated with the pay-per-click advertising.

21. The method as set forth in claim 1 further including:
providing the identified unexpected behavior to an output device including billing logic, used to determine a bill associated with the pay-per-click advertising;
acknowledging, by the billing logic, that the identified unexpected behavior is over a determined threshold;
providing the predicted behavior to the billing logic;
providing the observed behavior to the billing logic;
comparing the predicted behavior and the observed behavior; and
adjusting the bill associated with the pay-per-click advertising based on the comparing.

22. An apparatus for monitoring behavior associated with targeted advertising in a keyword searching environment, the apparatus including:
at least one observed behavior model for identifying observed behavior associated with the targeted advertising;
at least one predicted behavior model for identifying predicted behavior associated with the observed behavior; and
at least one comparator logic process in communication with one or more of the at least one observed behavior model and one or more of the at least one predicted behavior model for comparing the observed behavior to the predicted behavior to identify non-conforming behavior associated with the targeted advertising.

23. The apparatus as set forth in claim 22, further including:
a storage device in communication with the each comparator logic process for storing the non-conforming behavior.

24. The apparatus as set forth in claim 23, further including:
an output device in communication with the storage device for reporting the non-conforming behavior to at least one of a user or one or more components of the keyword searching environment.

25. The apparatus as set forth in claim 22 wherein the at least one observed behavior model includes an observed click-through behavior model, wherein the at least one predicted behavior model includes a predicted automated agent behavior model.

26. The apparatus as set forth in claim 24, the at least one predicted behavior model further including:
a predicted human user behavior model.

27. The apparatus as set forth in claim 22 wherein the at least one observed behavior model includes an observed keyword bid behavior model, an observed advertisement bid behavior model, an observed advertiser web site behavior model, a topic analysis process, or an observed keyword bid, advertisement bid, and advertiser web site content relevance behavior model, wherein the at least one predicted behavior model includes a predicted keyword bid, advertisement bid, and advertiser web site content relevance behavior model, wherein the at least one comparator logic process includes a first comparator logic process in communication with the observed keyword bid, advertisement bid, and advertiser web site content relevance behavior model and predicted keyword bid, advertisement bid, and advertiser web site content relevance behavior model to identify non-conforming behavior associated with low relevance of any combination of keywords, advertisement content, and advertiser web site content.

28. The apparatus as set forth in claim 27 wherein the at least one observed behavior model includes an observed click-through behavior model, wherein the at least one predicted behavior model includes a predicted click-through behavior model in communication with the observed keyword bid, advertisement bid, and advertiser web site content relevance behavior model, wherein the at least one comparator logic process includes a second comparator logic process in communication with the observed click-through behavior model and predicted click-through behavior model to identify non-conforming behavior associated with click-through rates for advertisements in search results lists associated with the keywords.

29. The apparatus as set forth in claim 22 wherein the at least one observed behavior model includes an observed regular search result behavior model and an observed regular search result web site behavior model, wherein the at least one predicted behavior model includes a predicted regular search result web site behavior model behavior model.

30. A computer program product for use with an apparatus for monitoring behavior associated with targeted advertising in a keyword searching environment, the computer program product including:
a computer usable medium having computer readable program code embodied in the medium for causing:
i) observation of behavior associated with the targeted advertising;
ii) prediction of behavior associated with the observed behavior;
iii) comparison of the observed behavior to the predicted behavior to identify non-conforming behavior associated with the targeted advertising;
iv) storage of the non-conforming behavior on a storage device; and
v) reporting of the non-conforming behavior to an output device.
